(19) United States
(12) Patent Application Publication
(10) Pub. No.: US 2003/0114179 A1
(43) Pub. Date: Jun. 19, 2003

(54) Method and apparatus for generating a quality measure target value based on channel conditions

(75) Inventors: Lev Smolyar, Givat-Shmuel (IL); Itzhak Bergel, Givat-Shmuel (IL)

Correspondence Address: Schwegman, Lundberg, Woessner & Kluth, P.A., P.O. Box 2938, Minneapolis, MN, 55402, US

(73) Assignee: D.S.P.C. TECHNOLOGIES LTD.

(21) Appl. No.: 10/021,541

(22) Filed: Dec. 17, 2001

(51) Int. Cl. H04B 7/00

(52) U.S. Cl. 455/522; 455/69

(57) ABSTRACT

A communication apparatus generates a quality measure target value (e.g., a signal to interference ratio (SIR) target) using channel parameters estimated for a corresponding communication channel.

### BACKGROUND OF THE INVENTION

Power control methods are often implemented within wireless communication systems to minimize transmission power while still maintaining a desired communication performance level. In one popular power control technique, a nested loop structure having an outer loop and an inner loop is used to control transmit power. In the outer loop, the block error rate (BLER) of received data is monitored and compared to a desired BLER. A signal to interference ratio (SIR) target is then developed for the receiver based on the comparison. In the inner loop, a measured SIR for a received signal is compared to the SIR target. A power control message may then be generated for delivery to the transmitter based on the result of the SIR comparison (e.g., indicating whether transmit power modifications are desirable). A problem with this power control technique (and other similar methods) is that the BLER measurement is relatively slow and, therefore, the transmit power is not able to adapt quickly to changes in channel conditions. As can be appreciated, this may result in poor communication quality in a communication system having a non-fixed channel.

### BRIEF DESCRIPTION OF THE DRAWINGS

FIG. 1 is a block diagram illustrating a prior art communication apparatus that is capable of performing power control functions;

FIG. 2 is a block diagram illustrating a communication apparatus in accordance with an embodiment of the present invention;

FIG. 3 is a block diagram illustrating one possible implementation of the apparatus of FIG. 2;

FIG. 4 is a block diagram illustrating a communication apparatus that is adapted for use within a cellular system implementing code division multiple access (CDMA) techniques in accordance with an embodiment of the present invention; and

FIG. 5 is a block diagram illustrating a communication apparatus that uses SIR target information to perform SSDT functions in accordance with an embodiment of the present invention.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention relates to methods and structures for updating a quality measure target value (e.g., an SIR target) in a communication system based on channel conditions. The methods and structures are capable of providing a relatively rapid response to changing channel conditions in the system. In a power control scenario, the use of channel condition information to update the quality measure target value can result in rapid convergence in a power control loop by eliminating the need to wait for corresponding error rate information. Error rate information may then be used to refine the quality measure target value when the error rate information is available. The methods and structures for updating a quality measure target value also have application in systems and devices that include a site selection diversity transmit (SSDT) mode of operation. The inventive principles may be used in a variety of different wireless communication system applications. The inventive principles are particularly beneficial in systems having channels that can change quickly with time (e.g., mobile communication systems).

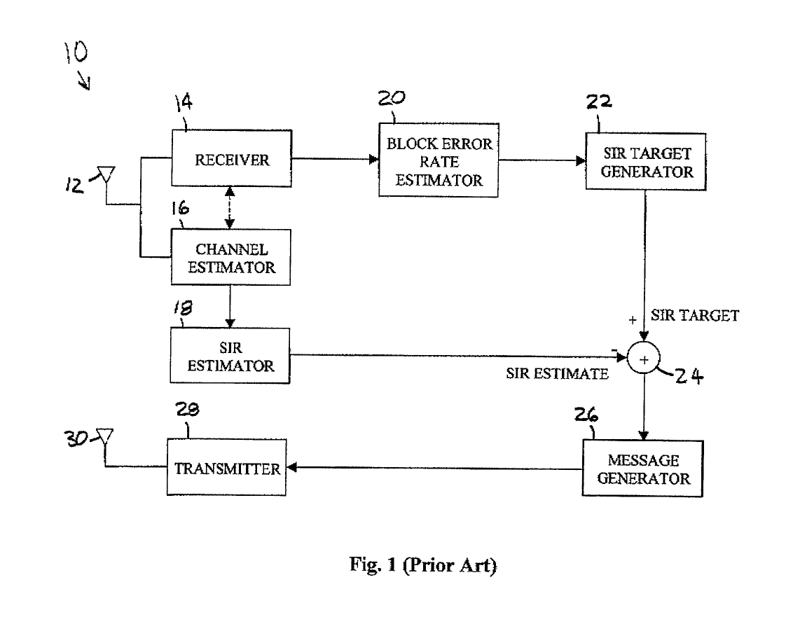

FIG. 1 is a block diagram illustrating a prior art communication apparatus 10 that is capable of performing power control functions. As illustrated, the communication apparatus 10 includes: a receive antenna 12, a receiver 14, a channel estimator 16, an SIR estimator 18, a block error rate estimator 20, an SIR target generator 22, a comparison unit 24, a message generator 26, a transmitter 28, and a transmit antenna 30. A communication signal is received from a remote transceiver, via a wireless communication channel, at receive antenna 12. The received signal is delivered to the receiver 14 and the channel estimator 16. The receiver 14 processes the received signal and converts it to a baseband representation. The channel estimator 16 processes the received signal to estimate channel parameters for the wireless channel. The block error rate estimator 20 receives the baseband information from the receiver 14 and uses the information to determine a block error rate (BLER) for the communication apparatus 10.

The SIR target generator 22 generates an SIR target for the communication apparatus 10 based on the estimated BLER determined by the block error rate estimator 20 and a desired BLER of the apparatus 10. The SIR estimator 18 estimates an SIR of the received signal using channel parameters determined by the channel estimator 16. The comparison unit 24 compares the estimated SIR to the SIR target generated by the SIR target generator 22 and outputs a comparison result to the message generator 26. The message generator 26 then generates a power control message based on the comparison result. The transmitter 28 and transmit antenna 30 are then used to transmit the message to the remote transceiver through a wireless channel. The message may include, for example, a request to increase or decrease the transmit power by a fixed amount. The receive and transmit antennas 12, 30 may be replaced by a single antenna with the addition of appropriate duplexing functionality.

Because error rates in communication systems are typically small, the process of measuring the BLER of received information will typically be relatively slow. That is, the convergence time will be at least on the order of 1/BLER. Thus, the SIR target that is generated by the SIR target generator 22 will typically be slow to react to changes in channel condition. For this reason, when channel conditions change, there may be periods during which the apparatus 10 is attempting to maintain an SIR (i.e., the SIR target) that is inadequate for achieving the desired BLER of the apparatus 10.

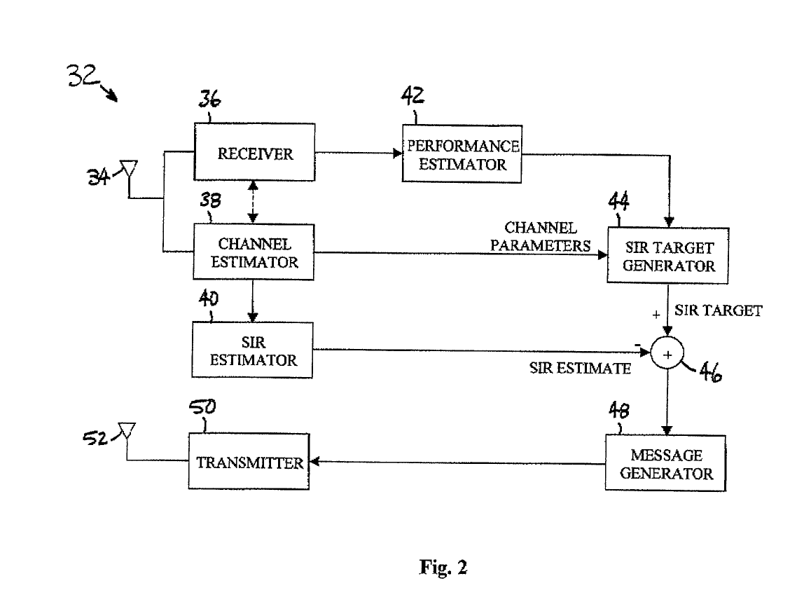

FIG. 2 is a block diagram illustrating a communication apparatus 32 in accordance with an embodiment of the present invention. As will be described in greater detail, the communication apparatus 32 is capable of updating an SIR target relatively quickly in response to a changing channel. The communication apparatus 32 may be implemented as any form of communication device or subsystem that may be used within a wireless communication system including, for example, a handheld communicator, a cellular base station transceiver, a satellite uplink, downlink, or crosslink transceiver, a transceiver within a terrestrial wireless link, a local multipoint distribution system (LMDS) or multipoint multichannel distribution system (MMDS) transceiver, a two-way radio, transceivers within wireless local area networks (LANs), metropolitan area networks (MANs), and wide area networks (WANs), wireless local loop transceivers, and others. As illustrated, the communication apparatus 32 includes: a receive antenna 34, a receiver 36, a channel estimator 38, an SIR estimator 40, a performance estimator 42, an SIR target generator 44, a comparison unit 46, a message generator 48, a transmitter 50, and a transmit antenna 52. Unlike the corresponding block within apparatus 10 of FIG. 1, the SIR target generator 44 of FIG. 2 uses channel parameters estimated by the channel estimator 38 to develop the SIR target. Performance information estimated by the performance estimator 42 (e.g., block error rate) may also be used by the SIR target generator 44 to develop the SIR target. By using channel parameters to develop the SIR target, the target is able to adapt quickly to changes in channel conditions before corresponding performance information has been measured. As before, the SIR of a receive signal is estimated by an SIR estimator 40 and is compared to the SIR target. A message may then be generated and delivered to a remote transceiver based on the comparison result.

It should be appreciated that the blocks illustrated in FIG. 2 (and in other block diagrams referred to herein) are functional in nature and do not necessarily represent discrete hardware elements. For example, in at least one embodiment, one or more of the blocks are implemented in software within a single (or multiple) digital processing device(s) in the apparatus 32. This may include, for example, a general purpose microprocessor, a digital signal processor (DSP), a reduced instruction set computer (RISC), a complex instruction set computer (CISC), a field programmable gate array (FPGA), an application specific integrated circuit (ASIC), and/or others, as well as combinations of the above.

The performance estimator 42 may estimate any type of performance information that may be useful for determining the SIR target value. This may include, for example, block error rate, bit error rate, symbol error rate, and other performance measures. The channel estimator 38 may estimate any form of channel information that may be needed by the SIR target generator 44 to determine an SIR target value. This may include, for example, the number of paths in the channel, the path strengths, mobile velocity, path fading rates, symbol energy variances, variances between symbols of different blocks, variance of total block energy, and/or others. In addition to the channel parameters used by the SIR target generator 44, the channel estimator 38 may also estimate any other channel parameters that may be required by the SIR estimator 40 or other functions within the communication apparatus 32.

In the illustrated embodiment, the comparison unit 46 is shown as a difference unit that determines a difference between the SIR target and the SIR estimate. Other comparison techniques and/or structures may alternatively be used (e.g., a ratio unit, etc.). When a difference unit is used, the message generator 48 may use the sign (and possibly the magnitude) of the difference to develop the message for delivery to the remote transceiver. For example, if the difference is negative, then the SIR estimate is larger than the SIR target and the message generator may generate a message requesting the remote transceiver to reduce the transmit power by a fixed amount (e.g., 1 decibel (dB)). If the difference is positive, then the SIR estimate is less than the SIR target and the message generator may generate a message requesting the remote transceiver to increase the transmit power by a fixed amount. The message generator 48 may alternatively require the magnitude of the difference to exceed a threshold level before a change in transmit power is requested. As will be appreciated, many alternative methods for developing a power control message can also be used. For example, the message generator 48 may simply send the difference information to the remote transceiver and let the remote transceiver make the power control decision based thereon. Similarly, the message generator 48 may send the SIR estimate and SIR target information to the remote transceiver, dispensing with the need for a comparison unit 46 within the communication apparatus 32. As will be appreciated, many other techniques for delivering power control information to a remote transceiver are also possible.

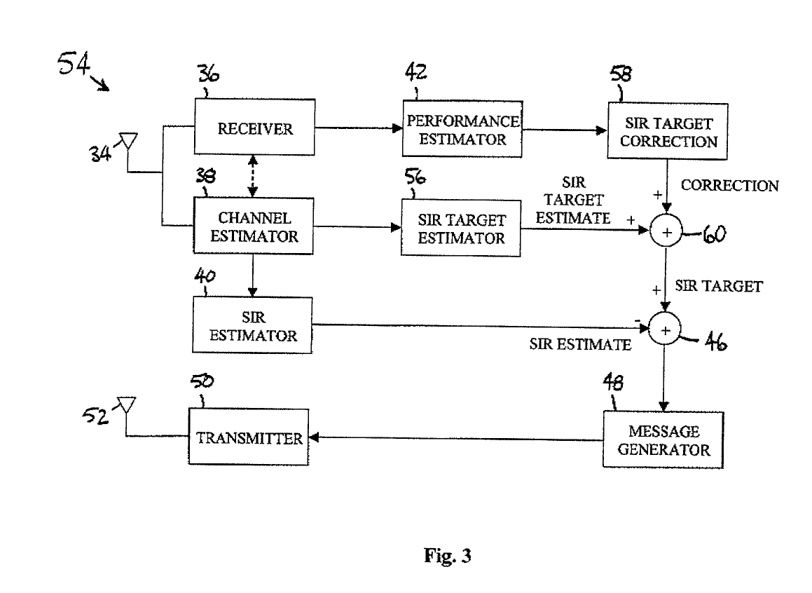

FIG. 3 is a block diagram illustrating a communication apparatus 54 that represents one possible implementation of the apparatus 32 of FIG. 2. As illustrated, an SIR target estimator 56 is provided to estimate the SIR target based on channel parameters developed by the channel estimator 38. An SIR target correction unit 58 is also provided to correct the estimate made by the SIR target estimator 56 when corresponding performance information (e.g., error rate information) is made available. A combination unit 60 combines the estimated SIR target with the correction information to generate the actual SIR target. In the illustrated embodiment, the combination unit 60 determines the sum of the estimated SIR target and the correction term. Many alternative combination techniques and/or structures can also be used.

In at least one embodiment of the invention, the performance estimator 42 determines the BLER of the receiver 36 for use by the SIR target correction unit 58 in developing the correction term. In general, the actual BLER of a wireless communication device will depend upon the format parameters of signals in the system (e.g., coding schemes, block length, etc.), the channel parameters, and the SIR target of the device (or another quality measure target value). Therefore, if the format parameters and desired BLER are known, it is theoretically possible to calculate the SIR target using the present channel parameters. Often, however, the function describing the relationship between the format parameters, the channel parameters, the BLER, and the SIR target is difficult to obtain, but many good approximations can be derived. In at least one implementation, the SIR target estimator 56 uses one of these approximations to determine the SIR target estimate.

Because the approximation is often relatively easy to calculate once the estimated channel parameters have been determined, the estimated SIR target can react quickly to changes in channel conditions. Once error information is available, the SIR target correction unit 58 can use the error information to correct the SIR target estimate. Thus, a relatively accurate SIR target value is available shortly after a change in channel conditions for use in achieving a desired error rate, even though corresponding measured error rate information has not yet been obtained. Thus, situations where a grossly inadequate SIR target value is used for an extended duration after a change in channel condition may be avoided. It should be appreciated that the SIR target approximation function will improve system timing even when the resulting estimates are not perfectly accurate. The fact that even some of the SIR target error is compensated by the approximation will decrease the correction term required from the SIR target correction unit 58, thus resulting in a shorter convergence time. In general, the more accurate the SIR target approximation is, the shorter the resulting convergence time will be. In at least one embodiment of the invention, the SIR target estimator 56 is used without an SIR target correction unit 58 (i.e., no correction based on measured performance level are made).

In one implementation, the SIR target estimator 56 approximates the SIR target using the following equation:

SIR target=C+D*σ²

where σ² is the variance of the total block energy (i.e., the amount of energy received on all of the code block symbols) and C and D are variables that depend upon parameters that are known a priori (e.g., coding scheme, bit rate, desired BLER, etc.). The variance σ² can be measured directly by the channel estimator 38 or it can be computed from other estimated channel parameters. In one approach, values for C and D are stored within a lookup table in the communication apparatus 54 and appropriate values are retrieved when needed.

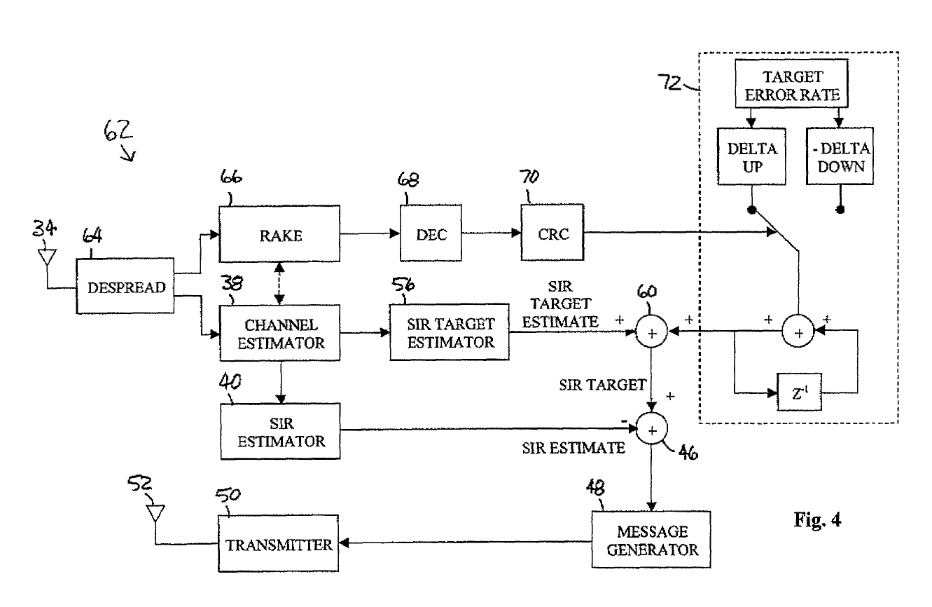

FIG. 4 is a block diagram illustrating a communication apparatus 62 in accordance with another embodiment of the present invention. The communication apparatus 62 is adapted for use within a cellular-type system implementing code division multiple access (CDMA) techniques. The communication apparatus 62 may be implemented as either a mobile communicator or a base station transceiver within the cellular-type system. As illustrated, the apparatus 62 includes: a receive antenna 34, a despreader 64, a rake receiver 66, a channel estimator 38, an SIR estimator 40, a decoder 68, a cyclic redundancy check (CRC) unit 70, an SIR target estimator 56, an SIR target correction unit 72, a combination unit 60, a comparison unit 46, a message generator 48, a transmitter 50, and a transmit antenna 52. When the apparatus 62 is implemented as a mobile communicator, the receive antenna 34 will receive spread spectrum CDMA signals from one or more remote base stations. The despreader 64 despreads one or more of the signals using CDMA techniques. The channel estimator 38 then processes the despread information to estimate channel parameters for the corresponding channel. The SIR estimator 40 then estimates an SIR of the received signal using channel parameters determined by the channel estimator 38. The SIR target estimator 56 estimates an SIR target value based on channel parameters determined by the channel estimator 38. The SIR target value is delivered to the combination unit 60.

The rake receiver 66 isolates various multipath components associated with a particular base station and combines them coherently. The decoder 68 decodes the resulting signal. The CRC 70 uses decoded signal information from the decoder 68 to detect and quantify CRC errors (e.g., as percentage of CRC errors) within the apparatus 62. The SIR target correction unit 72 updates a SIR target correction term according to each CRC result. A correct CRC will cause a decrease in the correction term by the constant DELTA_UP, while an error CRC will cause an increase in the correction term by the constant DELTA_DOWN. As described previously, the SIR target estimator 56 will typically respond quickly to changes in channel conditions. The SIR target correction unit 72 will then update the SIR target estimate once error information is available. The estimated SIR target is combined with the correction term in the combination unit 60 and the resulting SIR target is compared with the SIR estimate in the comparison unit 46. The message generator 48 then generates a message based upon the comparison results and the message is transmitted to the remote base station using the transmitter 50 and transmit antenna 52. A similar approach may be used when the communication apparatus 62 is implemented as a cellular base station, although the receive antenna 34 will receive CDMA signals from one or more remote users rather than one or more remote base stations.

In at least one aspect of the present invention, SIR target calculations are used within a cellular-based communication system to support a site selection diversity transmit (SSDT) mode of operation. In this mode of operation, a mobile communicator is capable of choosing which one of a number of different base stations will transmit to it at a particular time. For example, when the channel from one base station is fading, a mobile operating in SSDT mode can switch to another base station whose channel is not fading. During the transition from one base station to another, the channel conditions of the new base station are often completely different from the channel conditions of the previous base station. If the SIR target of the previous base station were used with the new base station, therefore, a relatively large SIR target error could result. Using the inventive principles, however, a relatively quick adjustment of the SIR target value can be made based on the channel condition of the new base station. In one approach, for example, a mobile keeps track of the channel conditions of each candidate base station during normal operation. Thus, an approximate SIR target value for a new base station may be available for use at the time the new base station is selected (or slightly after). Even if the channel conditions of the other base stations are not tracked, the quick response of the inventive SIR target calculation will typically hasten convergence for the new base station significantly.

In the past, mobiles operating in SSDT mode would typically select a base station based on the total power received from each candidate base. However, the performance of a receiver (e.g., BLER, etc.) may not be a function of receive power alone, but may also be a function of other channel parameters. Disregarding this fact can result in a transition to a base station that has a higher received power, but which results in a lower performance level. Therefore, in at least one embodiment of the invention, a system is provided that uses SIR target values that are calculated using estimated channel parameters as part of an SSDT-type base station selection criterion.

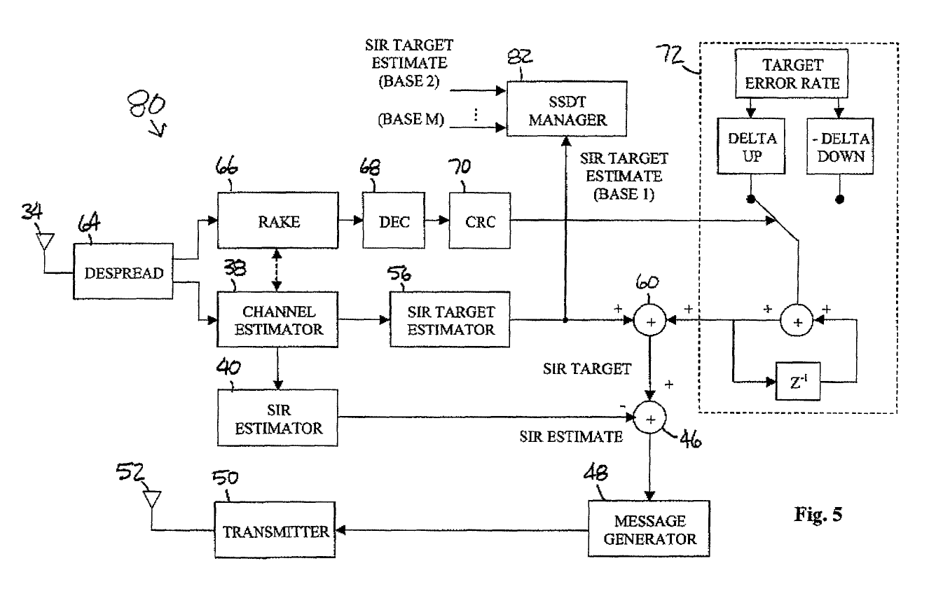

FIG. 5 is a block diagram illustrating a communication apparatus 80 that uses SIR target information to perform SSDT functions in accordance with an embodiment of the present invention. As illustrated, the apparatus 80 is similar to the apparatus 62 of FIG. 4; however, an SSDT manager 82 has been added. As shown, the SSDT manager 82 receives the present SIR target estimate from the SIR target estimator 56 for a base station (i.e., BASE 1) that is currently being tracked by the channel estimator 38. The SSDT manager 82 also receives SIR target estimates from SIR target estimators in the apparatus 80 that are associated with one or more other base stations (e.g., BASE 2—BASE M in FIG. 5). These other SIR target estimates are developed within other receive channels in the apparatus 80 that are the same as or similar to the one illustrated. The SSDT manager 82 uses the target estimates to select one of the base stations to act as the servicing base station for the apparatus 80. In addition to the SIR target estimates, the SSDT manager 82 may also consider other criteria as part of the base station selection process (e.g., total received power level of each base, etc.).

Instead of the SIR target estimates generated in the SIR target estimators 56, the SSDT manager 82 may use the corrected SIR target information output by the combination unit 60 (or other related information). Because the SIR target estimates (or the corrected SIR target information) will typically respond quickly to corresponding changes in channel conditions, the SSDT manager 82 maybe capable of dynamically selecting an optimal base station in near real time. This approach to base station selection can also be implemented in non-CDMA based cellular systems. In the apparatus 80 of FIG. 5, SIR target estimates are used as part of the SSDT base station selection process in an apparatus that also implements power control. It should be appreciated that these techniques can also be used in apparatuses that do not use power control.

In the embodiments described above, signal to interference ratio (SIR) is used as a communication quality measure. It should be appreciated that other measures of communication quality can alternatively be used in accordance with the present invention including, for example, signal to noise ratio (SNR), signal to interference and noise ratio (SINR), bit error rate, signal power, and others.

Although the present invention has been described in conjunction with certain embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A communication apparatus, comprising:
a channel estimator to estimate channel parameters for a communication channel based on a signal received from the communication channel; and
a quality measure target generator to generate a quality measure target value for the communication apparatus using channel parameters estimated by said channel estimator, said quality measure target value representing a desired value for a quality measure associated with the communication apparatus.

2. The communication apparatus of claim 1, wherein:
said quality measure target generator generates a signal to interference ratio (SIR) target value.

3. The communication apparatus of claim 1, wherein:
said quality measure target generator includes a quality measure target estimator to determine an estimated quality measure target value using channel parameters estimated by said channel estimator and a quality measure target correction unit to correct said estimated quality measure target value based on performance information.

4. The communication apparatus of claim 3, wherein:
said performance information includes block error rate (BLER) information.

5. The communication apparatus of claim 1, wherein:
said quality measure target generator generates said quality measure target value using symbol energy variance information associated with the communication channel.

6. The communication apparatus of claim 1, comprising:
a quality measure estimator to estimate an actual quality measure value for a signal received from the communication channel.

7. The communication apparatus of claim 6, comprising:
a message generator to generate a power control message based on the estimated quality measure value and the quality measure target value.

8. The communication apparatus of claim 1, wherein:
said communication apparatus is a handheld communicator.

9. The communication apparatus of claim 1, wherein:
said communication apparatus is a base station transceiver.

10. The communication apparatus of claim 1, wherein:
said communication apparatus is part of a code division multiple access (CDMA) system.

11. A method for generating a quality measure target value within a communication apparatus, comprising:
estimating channel parameters for a communication channel based on a signal received from the communication channel; and
calculating the quality measure target value using the estimated channel parameters.

12. The method of claim 11, wherein:
calculating the quality measure target value includes determining an estimated quality measure target value using the estimated channel parameters.

13. The method of claim 12, wherein:
calculating the quality measure target value further includes correcting the estimated quality measure target value based on performance information associated with the communication apparatus.

14. The method of claim 13, wherein:
said performance information includes block error rate (BLER) information.

15. The method of claim 11, wherein:
estimating channel parameters includes estimating at least one of the following: the number of paths in the communication channel, the strengths of paths in the communication channel, the relative velocity of the communication apparatus, the fading rates of paths in the communication channel, symbol energy variances in the communication channel, and variances between symbols of different blocks within the communication channel.

16. The method of claim 11, wherein:
calculating the quality measure target value includes calculating a signal to interference ratio (SIR) target.

17. A communication apparatus, comprising:
a channel estimator to estimate channel parameters for a communication channel based on a signal received from the communication channel;
a performance estimator to estimate a performance parameter of the communication apparatus; and
a quality measure target generator to generate a quality measure target value for the communication apparatus, wherein said quality measure target generator generates said quality measure target value using channel parameters estimated by said channel estimator and the estimated performance parameter determined by said performance estimator.

18. The communication apparatus of claim 17, wherein:
said performance estimator estimates a receive error rate of the communication apparatus and said quality measure target generator uses said receive error rate to generate the quality measure target value.

19. The communication apparatus of claim 17, wherein:
said quality measure target generator uses the channel parameters to determine an approximate quality measure target value and the estimated performance parameter to correct the approximate quality measure target value.

20. The communication apparatus of claim 17, wherein:
said channel estimator estimates at least one of the following: the number of paths in the communication channel, the strengths of paths in the communication channel, the relative velocity of the communication apparatus, the fading rates of paths in the communication channel, symbol energy variances in the communication channel, and variances between symbols of different blocks within the communication channel.

21. The communication apparatus of claim 17, comprising:
a quality measure estimator to estimate a quality measure of the signal received from the communication channel; and
a message generator to generate a power control message based on the estimated quality measure and the quality measure target value.

22. A mobile communicator, comprising:
a first quality measure target generator to generate a first quality measure target value for a first remote base station using estimated channel parameters for a communication channel between said mobile communicator and said first remote base station;
a second quality measure target generator to generate a second quality measure target value for a second remote base station using estimated channel parameters for a communication channel between said mobile communicator and said second remote base station; and
a site selection manager to select a remote base station to act as a servicing base station for the mobile communicator using at least said first quality measure target value and said second quality measure target value.

23. The mobile communicator of claim 22, wherein:
said first and second quality measure target generators include SIR target generators.

24. The mobile communicator of claim 22, comprising:
at least one other quality measure target generator to generate at least one other quality measure target value for at least one other remote base station, wherein said site selection manager uses said at least one other quality measure target value to select said remote base station to act as said servicing base station.

25. The mobile communicator of claim 22, further comprising:
a message generator to generate a power control message for a remote base station based on a corresponding quality measure target value.
